(19) United States
(12) Patent Application Publication
(10) Pub. No.: US 2014/0112153 A1
(43) Pub. Date: Apr. 24, 2014

(54) METHOD AND DEVICE FOR MANAGING CONTENTION WINDOW BASED ON TRANSMISSION ERROR DETECTION

(71) Applicant: Electronics and Telecommunications Research Institute, Daejeon (KR)

(72) Inventors: Sung Geun JIN, Daejeon (KR); Byung Jae KWAK, Daejeon (KR); Jin Kyeong KIM, Daejeon (KR); Sung Cheol CHANG, Daejeon (KR); Seung Chan BANG, Daejeon (KR)

(73) Assignee: Electronics and Telecommunications Research Institute, Daejeon (KR)

(21) Appl. No.: 14/061,953

(22) Filed: Oct. 24, 2013

(30) Foreign Application Priority Data
Oct. 24, 2012 (KR) 10-2012-0118326
Oct. 11, 2013 (KR) 10-2013-0121439

(51) Int. Cl. H04L 12/26

(52) U.S. Cl. CPC H04L 43/0847
USPC 370/242

(57) ABSTRACT

Disclosed is a method and apparatus for managing a contention window based on detection of a transmission error, the method including: recognizing a transmission failure of data in the case of transmitting data using a contention-based wireless channel access method; verifying whether the transmission failure of data occurs due to a channel error or a collision by a contention between terminals; and determining a value of a contention window set in association with data transmission based on the verification result.

### CROSS-REFERENCE TO RELATED APPLICATION

This application claims the priority benefit of Korean Patent Application No. 10-2012-0118326, filed on Oct. 24, 2012, and Korean Patent Application No. 10-2013-0121439, filed on Oct. 11, 2013, in the Korean Intellectual Property Office, the disclosure of which is incorporated herein by reference.

### BACKGROUND

1. Field

Embodiments of the present invention relate to a technique of enhancing an efficiency of a contention based wireless channel access method by distinguishing a collision by a contention between terminals from a channel error in a case in which data transmission fails, and thereby managing a contention window.

2. Description of Related Art

In a related art, a terminal to transmit data over a wireless network may transmit the data by occupying a wireless channel. In this instance, when the wireless channel is in a busy state in which the wireless channel is occupied by another terminal at a point in time when the data is to be transmitted, a collision may occur between terminals.

In this case, the terminal may transmit data without causing a collision in the wireless channel by determining a value of a contention window and by selecting a backoff count for waiting for data transmission based on the determined value of the contention window.

Also, the terminal may maximally avoid a collision between terminals by incrementing the value of the contention window every time the collision between the terminals occurs. The collision may occur in a case in which a terminal determines that the wireless channel is not occupied by another terminal and based thereon, transmits data and in this instance, the other terminal makes the same decision and thereby transmits data through the wireless channel.

However, even though an error occurs in the wireless channel itself, the terminal may erroneously determine that the error occurs due to the collision between the terminals and thereby increment the value of the contention window. In this case, transmission of data may be delayed.

For example, in the related art, the contention window may be managed without distinguishing a transmission error and a collision between terminals.

Accordingly, there is a technique of enhancing an efficiency of a contention based wireless channel access method by distinguishing a case in which a collision occurs due to a contention between terminals from a case in which a channel error occurs and thereby limiting adjustment of the contention window.

### SUMMARY

An aspect of the present invention is to enhance an efficiency of a contention based wireless channel access method by distinguishing a collision by a contention between terminals from a channel error and thereby managing a contention window.

Another aspect of the present invention is to optimally apply a channel error and a contention between terminals attempting to access a channel to a currently determined value of a contention window.

According to an aspect of the present invention, there is provided a method of managing a contention window based on detection of a transmission error, the method including: recognizing a transmission failure of data in the case of transmitting data using a contention-based wireless channel access method; verifying whether the transmission failure of data occurs due to a channel error or a collision by a contention between terminals; and determining a value of a contention window set in association with data transmission based on the verification result.

According to another aspect of the present invention, there is provided an apparatus for managing a contention window based on detection of a transmission error, the apparatus including: a recognizer to recognize a transmission failure of data in the case of transmitting data using a contention-based wireless channel access method; a verifier to verify whether the transmission failure of data occurs due to a channel error or a collision by a contention between terminals; and a determiner to determine a value of a contention window set in association with data transmission based on the verification result.

### EFFECTS

According to embodiments of the present invention, it is possible to enhance an efficiency of a contention based wireless channel access method by distinguishing a collision by a contention between terminals from a channel error and thereby managing a contention window.

Also, according to embodiments of the present invention, it is possible to optimally apply a channel error and a contention between terminals attempting to access a channel to a currently determined value of a contention window.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a contention window management device according to an embodiment of the present invention;

FIG. 2 is a diagram illustrating an example of a network configuration associated with a terminal including a contention window management device according to an embodiment of the present invention; and

FIG. 3 is a flowchart illustrating a method of managing a contention window according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A contention based wireless channel access method used throughout the present specification may refer to a method of enabling a plurality of users, for example, a plurality of terminals to transmit data to another terminal using the same single wireless channel. In the contention based wireless channel access method, minimizing a transmission failure of data occurring due to a collision between a plurality of terminals, for example, a collision occurring when the plurality of terminals transmits data using the same wireless channel in the same time zone, and optimally guaranteeing transmission of data becomes the most important issue.

To this end, the contention based wireless channel access method may maximally prevent the occurrence of the collision between the terminals by setting a time for transmitting data for each terminal.

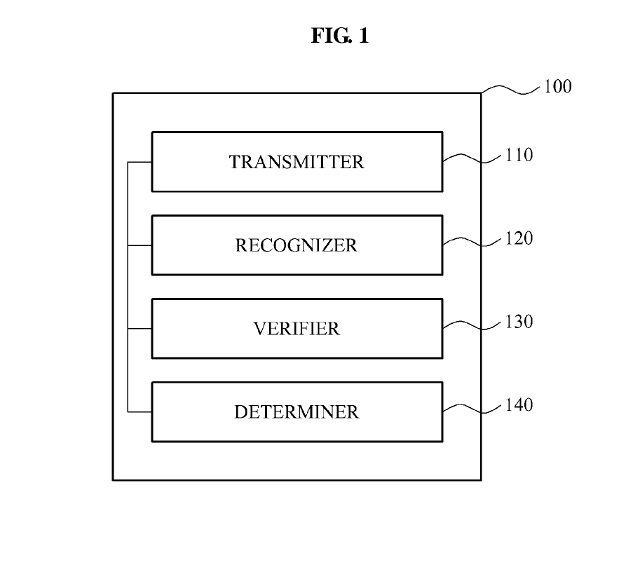

FIG. 1 is a block diagram illustrating a configuration of a contention window management device 100 according to an embodiment of the present invention.

Referring to FIG. 1, the contention window management device 100 may include a transmitter 110, a recognizer 120, a verifier 130, and a determiner 140.

The transmitter 110 may transmit data using a contention based wireless channel access method. The transmitter 110 may serve to transmit data through a wireless channel. The data may include control information required for the above transmission and address information of a node corresponding to a transmission path on a network.

The recognizer 120 may recognize a transmission failure of data in the case of transmitting data using the contention-based wireless channel access method. The recognizer 120 may serve to recognize that data transmitted through the wireless channel is not wholly received at a reception end. Here, the recognizer 120 may recognize the transmission failure of data when the terminal including the contention window management device 100 is switched to a reception mode.

For example, when a response to transmission of data is not input within a predetermined amount of time, the recognizer 120 may recognize the transmission failure of data.

Also, when an error is input as the response to the transmission of data, the recognizer 120 may recognize the transmission failure of data.

The verifier 130 may verify whether the transmission failure of data occurs due to a channel error or a collision by a contention between terminals using other methods. The verifier 130 may serve to verify a type of the transmission failure of data transmitted to the reception end. The method related thereto is not included in the description scope of the present invention.

For example, in the case of a terminal that switches from a data transmission mode to a reception mode after transmitting data to another terminal in the data transmission mode, the verifier 130 may receive, from the other terminal, a notification indicating that a transmission failure of data has occurred due to a collision in a wireless channel and accordingly, may verify that a reason for the transmission failure of data is a collision by a contention between terminals.

The determiner 140 may determine a value of a contention window set in association with data transmission based on the verification result. The determiner 140 may serve to determine whether to adjust the value of the contention window based on the type of the transmission failure of data transmitted to the reception end.

For example, when the transmission failure of data is verified to occur due to the collision by the contention between the terminals, the determiner 140 may increment the value of the contention window so that the data may be retransmitted to the reception end through the transmitter 110 based on the incremented value of the contention window.

For example, when a current value of the contention window is “2⁴(=16)” and the transmission failure of data is verified to occur due to the collision by the contention between the terminals, the determiner 140 may increment the value of the contention window to be 2⁵(=32), and may select a predetermined value between “0” and “2⁵−1(=31)” as a backoff count for waiting for transmission of data. Here, the value of the contention window to be incremented may have no need to be uniformly a multiple of “2” and may need to be greater than a previous value. A method of incrementing the value of the contention window is not included in the description scope of the present invention.

In this example, when a transmission failure of the retransmitted data is verified to occur due to the collision by the contention between the terminals, the determiner 140 may gradually increment the value of the contention window, for example, to be “2⁶(=64)”, “2⁷(=128)”, . . . , and may retransmit the data based on the incremented value of the contention window. When retransmission of the data continuously fails within a predetermined number of times, the determiner 140 may suspend transmission of the data and initialize the value of the contention window.

That is, when the wireless channel cannot be continuously used due to the collision, the determiner 140 may discard corresponding data and transmit subsequent data.

Depending on embodiments, when the transmission failure of data is not recognized, that is, when the data is successfully transmitted, the determiner 140 may initialize the value of the contention window or may decrement the value of the contention window to be a predetermined value. A method of decrementing the value of the contention window when transmission of data succeeds is not included in the description scope of the present invention. For example, the determiner 140 may recognize that data is normally transmitted to the reception end and thereby transmit subsequent data.

Also, the determiner 140 may select a predetermined value between the determined value of the contention window and “0” as a backoff count, and may decrement the backoff count by each “1” every time a predetermined amount of time is elapsed and retransmit the data when the backoff count becomes “0”.

For example, when the transmission failure of data is verified to occur due to the channel error, the determiner 140 may maintain the contention window to have a current value so that the data may be retransmitted to the reception end through the transmitter 110 based on the maintained contention window.

For example, when a current value of the contention window is “2⁴(=16)” and the transmission failure of data is verified to occur due to a defect of a transmission system or other reasons, the determiner 140 may enable the backoff count for waiting transmission of data to be selected from among values between “0” and “2⁴−1(=15)” while maintaining “2⁴(=16)” instead of adjusting the value of the contention window.

According to embodiments of the present invention, it is possible to enhance an efficiency of a contention based wireless channel access method by distinguishing a collision by a contention between terminals from a channel error in a case in which a data transmission fails, and thereby managing a contention window.

Also, according to embodiments of the present invention, it is possible to optimally apply a channel error and a contention between terminals attempting to access a channel to a currently determined value of a contention window.

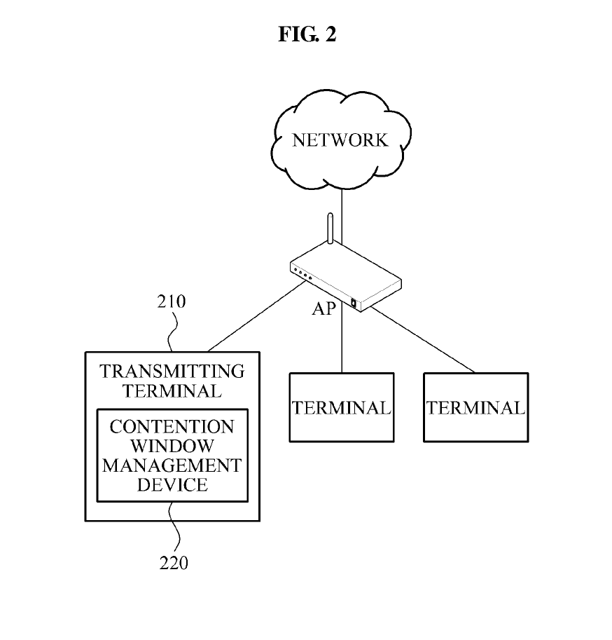

FIG. 2 is a diagram illustrating an example of a network configuration associated with a terminal including a contention window management device 220 according to an embodiment of the present invention.

Referring to FIG. 2, the contention window management device 220 may be included in a transmitting terminal 210 to transmit data through a wireless channel using a contention method with other terminals.

To this end, the transmitting terminal 210 including the contention window management device 220 may be connected to a network through an access point (AP). The AP may create electric waves and transfer data of the transmitting terminal 210 to the network.

The transmitting terminal 210 and the AP may communicate with each other through a wireless channel access control protocol standardized in the network.

The contention window management device 220 may transmit data of the transmitting terminal 210 through the wireless channel using the contention based wireless channel access method. The data may include control information used to transmit the data.

The contention based wireless channel access method is widely used in an Institute of Electrical and Electronics Engineers (IEEE) 802.11 wireless local area network (WLAN), an IEEE 802.15.4 ZigBee, mobile WiMAX, and the like. The contention based wireless channel access method generally widely used may be operated according to the following procedure.

The contention window management device 220 may autonomously manage a contention window (CW). Every time a collision occurs, the contention window management device 220 may increment a value of the contention window to be a value of a subsequent operation, starting from CWmin up to CWmax.

For example, in the case of an IEEE 802.11 media access control (MAC), the contention window management device 220 may gradually increment the value of the contention window (CW) every time the collision occurs, starting from “2⁴(=16)” corresponding to CWmin to “2⁶(=64)”, “2⁷(=128)”, “2⁸(=256)”, “2⁹(=512)”, and then up to “2¹⁰(=1024)” corresponding to CWmax.

When a current value of the contention window is determined as “2⁴(=16)”, the contention window management device 220 may select a predetermined value between “2⁴−1(=15)” and “0” as a backoff count.

For example, when “15” is selected as the backoff count from among values between “2⁴−1(=15)” and “0”, the contention window management device 220 may decrement the value of the contention window by each “1” from “15”, every time a predetermined amount of time is elapsed.

In this example, when a wireless channel being used by another user is detected during a standby process based on an IEEE 802.11 WLAN standard, that is, when an energy value is greater than or equal to a predetermined value as a result of sensing the wireless channel, the contention window management device 220 may verify that the wireless channel is busy and may suspend an operation of decrementing the backoff count.

On the contrary, when the wireless channel is not being used by any user, that is, when the wireless channel is in an idle state, the contention window management device 220 may resume an operation of decrementing the backoff-count by each “1”.

When the backoff count is continuously decremented and thereby reaches “0”, the contention window management device 220 may transmit data through the wireless channel.

When transmission is completed, the contention window management device 220 may wait for an acknowledgement (ACK) to be received during a predetermined amount of time in order to verify whether the data is accurately transferred to the reception end. In this example, when the ACK is not received, or when an error is detected in ACK reception, the contention window management device 220 may verify that transmission of the data is a failure and may increment the value of the contention window from “2⁴(=16)” to “2⁵(=32)” and then retransmit data.

Also, when retransmission of the data fails, the contention window management device 220 may gradually increment the value of the contention window up to “2¹⁰(=1024)” corresponding to CWmax and then repeat retransmission of the data.

Here, when transmission fails again even though the contention window reaches CWmax even after repeatedly retransmitting data, the contention window management device 220 may not attempt to transmit the data anymore and instead, may initialize the value of the contention window and then prepare to transmit new data.

When retransmission of data succeeds, the contention window management device 220 may reset the value of the contention window to an initial value and may attempt to transmit new data.

The contention window management device 220 of the present invention may manage the contention window by distinguishing the collision and the channel error in the case of performing data transmission.

For example, when the transmission fails due to the collision, the contention window management device 220 may increment the value of the contention window using an existing method. When the transmission fails due to the channel error, the contention window management device 220 may attempt to retransmit data by applying a current value of the contention window as is instead of incrementing the value of the contention window.

Accordingly, the contention window management device 220 may prevent a degradation in the transmission efficiency that may occur in the case of unnecessarily incrementing the value of the contention window.

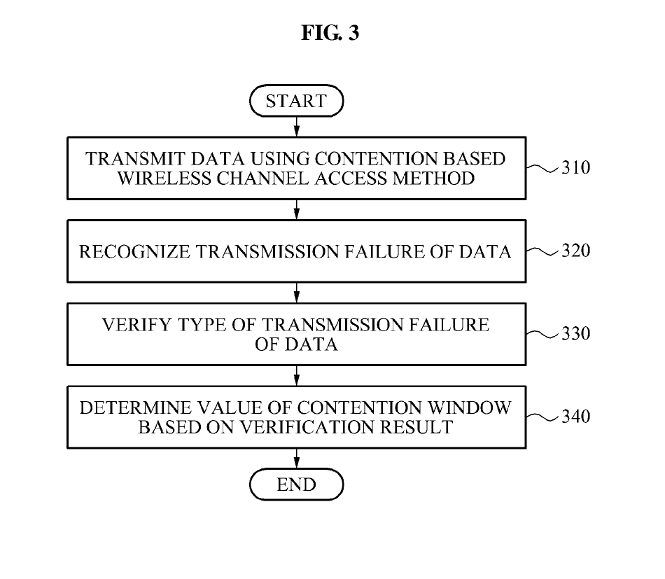

FIG. 3 is a flowchart illustrating a method of managing a contention window according to an embodiment of the present invention.

In operation 310, a contention window management device may transmit data using a contention based wireless channel access method. Operation 310 may be a process of transmitting data to a reception end through a wireless channel. The data may include control information required for the above transmission and address information of a node corresponding to a transmission path on a network.

In operation 320, the contention window management device may recognize a transmission failure of data in the case of transmitting data using the contention-based wireless channel access method. Operation 320 may be a process of recognizing that data transmitted through the wireless channel is not wholly received at the reception end. Here, the contention window management device may recognize the transmission failure of data when the terminal is switched to a reception mode.

When a response to transmission of data is not input within a predetermined amount of time, the contention window management device may recognize the transmission failure of data in operation 320.

Also, when an error is input as the response to the transmission of data, the contention window management device may recognize the transmission failure of data.

In operation 330, the contention window management device may verify whether the transmission failure of data occurs due to a channel error or a collision by a contention between terminals using other methods. Operation 330 may be a process of verifying a type of the transmission failure of data transmitted to the reception end.

For example, in the case of a terminal that switches from a data transmission mode to a reception mode after transmitting data to another terminal in the data transmission mode, the contention window management device may receive, from the other terminal, a notification indicating that a transmission failure of data has occurred due to a collision in a wireless channel and accordingly, may verify that a reason for the transmission failure of data is a collision by a contention between terminals.

In operation 340, the contention window management device may determine a value of a contention window set in association with data transmission based on the verification result. Operation 340 of may be a process of determining whether to adjust the value of the contention window based on the type of the transmission failure of data transmitted to the reception end.

For example, when the transmission failure of data is verified to occur due to the collision by the contention between the terminals, the contention window management device may increment the value of the contention window so that the data may be retransmitted to the reception end based on the incremented value of the contention window.

For example, when a current value of the contention window is “2⁴(=16)” and the transmission failure of data is verified to occur due to the collision by the contention between the terminals, the contention window management device may increment the value of the contention window to be “2⁵(=32)”, and may select a predetermined value between “0” and “2⁵−1(=31)” as a backoff count for waiting for transmission of data. Here, the value of the contention window to be incremented may have no need to be uniformly a multiple of “2” and may need to be greater than a previous value. A method of incrementing the value of the contention window is not included in the description scope of the present invention.

In this example, when a transmission failure of the retransmitted data is verified to occur due to the collision by the contention between the terminals, the contention window management device may gradually increment the value of the contention window, for example, to be “2⁶(=64)”, “2⁷(=128)”, . . . , and may retransmit the data based on the incremented value of the contention window. When retransmission of the data continuously fails within a predetermined number of times, the contention window management device may suspend transmission of the data and initialize the value of the contention window.

That is, when the wireless channel cannot be continuously used due to the collision, the contention window management device may discard corresponding data and transmit subsequent data.

Depending on embodiments, when the transmission failure of data is not recognized, that is, when the data is successfully transmitted, the contention window management device may initialize the value of the contention window or may decrement the value of the contention window to be a predetermined value. A method of decrementing the value of the contention window when transmission of data succeeds is not included in the description scope of the present invention. For example, the contention window management device may recognize that data is normally transmitted to the reception end and thereby transmit subsequent data.

Also, depending on embodiments, the contention window management device may select a predetermined value between the determined value of the contention window and “0” as a backoff count, and may decrement the backoff count one by each “1” every time a predetermined amount of time is elapsed and retransmit the data when the backoff count becomes “0”.

For example, when the transmission failure of data is verified to occur due to the channel error, the contention window management device may maintain the contention window to have a current value so that the data may be retransmitted to the reception end based on the maintained contention window.

For example, when a current value of the contention window is “2⁴(=16)” and the transmission failure of data is verified to occur due to a defect of a transmission system or other reasons, the contention window management device may enable the backoff count for waiting transmission of data to be selected from among values between “0” and “2⁴−1(=15)” while maintaining “2⁴(=16)” instead of adjusting the value of the contention window.

According to embodiments of the present invention, it is possible to enhance an efficiency of a contention based wireless channel access method by distinguishing a collision by a contention between terminals from a channel error in a case in which a data transmission fails, and thereby managing a contention window.

Also, according to embodiments of the present invention, it is possible to optimally apply a channel error and a contention between terminals attempting to access a channel to a currently determined value of a contention window.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of managing a contention window based on detection of a transmission error, the method comprising:
recognizing a transmission failure of data in the case of transmitting data using a contention-based wireless channel access method;
verifying whether the transmission failure of data occurs due to a channel error or a collision by a contention between terminals; and
determining a value of a contention window set in association with data transmission based on the verification result.

2. The method of claim 1, wherein the determining comprises determining to maintain the contention window to have a current value when the transmission failure of data is verified to occur due to the channel error.

3. The method of claim 2, further comprising:
retransmitting the data based on the maintained contention window.

4. The method of claim 1, wherein the determining comprises incrementing the value of the contention window when the transmission failure of data is verified to occur due to the collision by the contention between the terminals.

5. The method of claim 4, further comprising:
retransmitting the data based on the incremented value of the contention window.

6. The method of claim 5, further comprising:
incrementing the value of the contention window and retransmitting the data when a transmission failure of the retransmitted data is verified to occur due to the collision by the contention between the terminals, and suspending transmission of the data and initializing the value of the contention window when retransmission of the data continuously fails within a predetermined number of times.

7. The method of claim 1, wherein the recognizing comprises recognizing the transmission failure of data when a response to transmission of the data is not input within a predetermined amount of time.

8. The method of claim 1, wherein the recognizing comprises recognizing the transmission failure of data when an error is input in response to transmission of the data.

9. The method of claim 1, further comprising:
initializing the value of the contention window when the data transmission error is not recognized.

10. The method of claim 1, further comprising:
selecting a predetermined value between the determined value of the contention window and “0” as a backoff count; and
decrementing the backoff count by each “1” every time a predetermined amount of time is elapsed, and retransmitting the data when the backoff count becomes “0”.

11. An apparatus for managing a contention window based on detection of a transmission error, the apparatus comprising:
a recognizer to recognize a transmission failure of data in the case of transmitting data using a contention-based wireless channel access method;
a verifier to verify whether the transmission failure of data occurs due to a channel error or a collision by a contention between terminals; and
a determiner to determine a value of a contention window set in association with data transmission based on the verification result.

12. The apparatus of claim 11, wherein when the transmission failure of data is verified to occur due to the channel error, the determiner determines to maintain the contention window to have a current value.

13. The apparatus of claim 12, wherein the transmitter retransmits the data based on the maintained contention window.

14. The apparatus of claim 11, wherein when the transmission failure of data is verified to occur due to the collision by the contention between the terminals, the determiner increments the value of the contention window.

15. The apparatus of claim 14, wherein the transmitter retransmits the data based on the incremented value of the contention window.

16. The apparatus of claim 15, wherein
when a transmission failure of the retransmitted data is verified to occur due to the collision by the contention between the terminals the determiner increments the value of the contention window and retransmits the data, and
when retransmission of the data continuously fails within a predetermined number of times, the determiner suspends transmission of the data and initializes the value of the contention window.

17. The apparatus of claim 11, wherein when a response to transmission of the data is not input within a predetermined amount of time, the recognizer recognizes the transmission failure of data.

18. The apparatus of claim 11, wherein when an error is input in response to transmission of the data, the recognizer recognizes the transmission failure of data.

19. The apparatus of claim 11, wherein when the data transmission error is not recognized, the determiner initializes the value of the contention window.

20. The apparatus of claim 11, wherein the determiner selects a predetermined value between the determined value of the contention window and “0” as a backoff count, and decrements the backoff count by each “1” every time a predetermined amount of time is elapsed, and retransmits the data when the backoff count becomes “0”.
